(19) United States
(12) Patent Application Publication
(10) Pub. No.: US 2025/0103639 A1
(43) Pub. Date: Mar. 27, 2025

(54) SYSTEM AND METHOD FOR MACHINE LEARNING-DRIVEN DATA RECORD RETRIEVAL VIA STOCHASTIC EXPANSION DATA QUERYING

(71) Applicant: BANK OF AMERICA CORPORATION, Charlotte, NC (US)

(72) Inventors: Yvonne Y. Li, Jersey City, NJ (US); Aaron Blogg, New York, NY (US); Nizar Naitlho, Jersey City, NJ (US)

(73) Assignee: BANK OF AMERICA CORPORATION, Charlotte, NC (US)

(21) Appl. No.: 18/373,331

(22) Filed: Sep. 27, 2023

(51) Int. Cl. G06F 16/35; G06F 11/34; G06F 16/33; G06F 40/40

(52) U.S. Cl. CPC G06F 16/358; G06F 11/3457; G06F 16/3347; G06F 40/40

(57) ABSTRACT

Systems, computer program products, and methods are described herein for machine learning-driven data record retrieval via stochastic expansion data querying. Data records and a query statement are received. Using a weighting model, a data vector for each of the data records and a query vector for the query statement are generated. A first similarity score for each data vector is determined. Rankings for the data records are generated. Based on the rankings, a grouping of data records is selected. Test vectors centered from the query vector are then generated stochastically. A second similarity score for each of the test vectors is determined. A subsequent query vector is determined based on a highest second similarity score. If metrics do not satisfy a predetermined stopping criteria, subsequent test vectors are generated stochastically. Ranked data records are then provided to a large language model.

### FIELD OF THE INVENTION

The present invention embraces a system for machine learning-driven data record retrieval via stochastic expansion data querying.

### BACKGROUND

In the realm of data records, documentation applications play a pivotal role. One challenge involves the comprehensive analysis of documentation applications, which contain a wide range of useful data records entered by users associated with an entity. In some applications, these documentation applications serve as one of the main considerations that entity teams use to make decisions. However, the process of manually reviewing all rata records within a documentation application and extracting the data records relevant to their information needs is a time-consuming and resource-intensive task. Current search capabilities of data records within documentation applications are extremely limited, as they are restricted to basic keyword matching, which requires exact spelling and the order of keywords or phrases to appear in the body of the note. The end-to-end journey of extracting valuable insights from documentation applications is hindered by this limitation. This process inhibits the efficiency of various entity teams and hampers their ability to make timely and informed decisions. Accordingly, there is a need for a system and method for machine learning-driven data record retrieval via stochastic expansion data querying.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In one aspect, a system for machine learning-driven data record retrieval via stochastic expansion data querying is presented. The system may include a processing device, and a non-transitory storage device including instructions that, when executed by the processing device, causes the processing device to perform the steps of retrieving a plurality of data records from a data repository, receiving a query statement from an endpoint device, wherein the query statement is provided to the endpoint device at a user interface, generating, using a weighting model, a data vector for each of the data records and a query vector for the query statement, determining a first similarity score for each data vector, wherein the first similarity score corresponds to a similarity between each data vector and the query vector, generating rankings for each of plurality of data records based on the first similarity scores, selecting, based on the rankings, a grouping including a predetermined number of the data records with maximized first similarity scores, and generating, stochastically, test vectors centered from the query vector at a predetermined radius, wherein a quantity of test vectors generated is predetermined.

In some embodiments, the instructions further cause the processing device to perform the steps of determining a second similarity score for each of the test vectors, wherein the second similarity scores correspond to a similarity between each test vector and each data vector of the grouping, determining a subsequent query vector including the test vector including a highest second similarity score of each of the test vectors, and comparing metrics to a predetermined stopping criteria.

In some embodiments, wherein upon a condition in which the metrics do not satisfy the predetermined stopping criteria, the instructions further cause the processing device to perform the steps of generating, stochastically, subsequent test vectors centered from the subsequent query vector at a predetermined radius, wherein a quantity of the subsequent test vectors generated is predetermined, determining a similarity score for each of the subsequent test vectors, wherein the similarity score corresponds to a similarity between each subsequent test vector and each data vector of the grouping, and determining a new subsequent query vector including a subsequent test vector including a highest similarity score of each of the subsequent test vectors.

In some embodiments, the instructions further cause the processing device to perform the steps of repeating the conditional performing until the new metrics satisfy the predetermined stopping criteria.

In some embodiments, the instructions further cause the processing device to perform the steps of determining a final ranking of the data records, providing the final ranking of the data records to a large language model as a few-shot input to output as query results, wherein the query results are ranked based on the few-shot input, and transmitting the query results to the endpoint device for display on the user interface of the endpoint device.

In some embodiments, the first similarity score and the second similarity score are cosine similarity scores.

In some embodiments, the metrics may include at least one of the second similarity score, and a third similarity score corresponding to a similarity between each of the test vectors and the new query vector.

In another aspect, a computer program product for machine learning-driven data record retrieval via stochastic expansion data querying is presented. The computer program product may include a non-transitory computer-readable medium including code causing an apparatus to retrieve a plurality of data records from a data repository, receive a query statement from an endpoint device, wherein the query statement is provided to the endpoint device at a user interface, generate, using a weighting model, a data vector for each of the data records and a query vector for the query statement, determine a first similarity score for each data vector, wherein the first similarity score corresponds to a similarity between each data vector and the query vector, generate rankings for each of plurality of data records based on the first similarity scores, select, based on the rankings, a grouping including a predetermined number of the data records with maximized first similarity scores, and generate, stochastically, test vectors centered from the query vector at a predetermined radius, wherein a quantity of test vectors generated is predetermined.

In some embodiments, the code further causes the apparatus to determine a second similarity score for each of the test vectors, wherein the second similarity scores correspond to a similarity between each test vector and each data vector of the grouping, determine a subsequent query vector including the test vector including a highest second similarity score of each of the test vectors, and compare metrics to a predetermined stopping criteria.

In some embodiments, wherein upon a condition in which the metrics do not satisfy the predetermined stopping criteria, the code further causes the apparatus to generate, stochastically, subsequent test vectors centered from the subsequent query vector at a predetermined radius, wherein a quantity of the subsequent test vectors generated is predetermined, determine a similarity score for each of the subsequent test vectors, wherein the similarity score corresponds to a similarity between each subsequent test vector and each data vector of the grouping, and determine a new subsequent query vector including a subsequent test vector including a highest similarity score of each of the subsequent test vectors.

In some embodiments, the code further causes the apparatus to repeat the conditional performing until the new metrics satisfy the predetermined stopping criteria.

In some embodiments, the code further causes the apparatus to determine a final ranking of the data records, provide the final ranking of the data records to a large language model as a few-shot input to output query results, wherein the query results are ranked based on the few-shot input, and transmit the query results to the endpoint device for display on the user interface of the endpoint device.

In some embodiments, the first similarity score and the second similarity score are cosine similarity scores.

In some embodiments, the metrics may include at least one of the second similarity score, and a third similarity score corresponding to a similarity between each of the test vectors and the new query vector.

In yet another aspect, a method for machine learning-driven data record retrieval via stochastic expansion data querying is presented. The method may include retrieving a plurality of data records from a data repository, receiving a query statement from an endpoint device, wherein the query statement is provided to the endpoint device at a user interface, generating, using a weighting model, a data vector for each of the data records and a query vector for the query statement, determining a first similarity score for each data vector, wherein the first similarity score corresponds to a similarity between each data vector and the query vector, generating rankings for each of plurality of data records based on the first similarity scores, selecting, based on the rankings, a grouping including a predetermined number of the data records with maximized first similarity scores, and generating, stochastically, test vectors centered from the query vector at a predetermined radius, wherein a quantity of test vectors generated is predetermined.

In some embodiments, the method further may include determining a second similarity score for each of the test vectors, wherein the second similarity scores correspond to a similarity between each test vector and each data vector of the grouping, determining a subsequent query vector including the test vector including a highest second similarity score of each of the test vectors, and comparing metrics to a predetermined stopping criteria.

In some embodiments, wherein upon a condition in which the metrics do not satisfy the predetermined stopping criteria, the method further may include, generating, stochastically, subsequent test vectors centered from the subsequent query vector at a predetermined radius, wherein a quantity of the subsequent test vectors generated is predetermined, determining a similarity score for each of the subsequent test vectors, wherein the similarity score corresponds to a similarity between each subsequent test vector and each data vector of the grouping, and determining a new subsequent query vector including a subsequent test vector including a highest similarity score of each of the subsequent test vectors.

In some embodiments, the method further may include repeating the conditional performing until the new metrics satisfy the predetermined stopping criteria.

In some embodiments, the method further may include determining a final ranking of the data records, providing the final ranking of the data records to a large language model as a few-shot input to output query results, wherein the query results are ranked based on the few-shot input, and transmitting the query results to the endpoint device for display on the user interface of the endpoint device.

In some embodiments, the first similarity score and the second similarity score are cosine similarity scores.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIGS. 1A-1C illustrate technical components of an exemplary distributed computing environment for machine learning-driven data record retrieval via stochastic expansion data querying, in accordance with an embodiment of the invention;

FIGS. 2A-2C illustrate a process flow for machine learning-driven data record retrieval via stochastic expansion data querying, in accordance with an embodiment of the invention;

FIG. 3 illustrates a framework for data record retrieval, in accordance with an embodiment of the invention;

FIG. 4 illustrates an exemplary weighting model vector encoding, in accordance with an embodiment of the invention;

FIG. 5 illustrates an exemplary stochastic query expansion technique, in accordance with an embodiment of the invention; and

FIG. 6 illustrates an exemplary graphs of stochastic query expansion technique, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, a “user” may be an employee (e.g., an associate, a project manager, an IT specialist, a manager, an administrator, an internal operations analyst, or the like) of the entity or enterprises affiliated with the entity, capable of operating the systems described herein. In some embodiments, a “user” may be any individual, entity or system who has a relationship with the entity, such as a customer or a prospective customer. In other embodiments, a user may be a system performing one or more tasks described herein.

As used herein, a “interface” may be any device or software that allows a user to input information, such as commands or data, into a device, or that allows the device to output information to the user. For example, the interface includes a graphical user interface (GUI) or an interface to input computer-executable instructions that direct a processing device to carry out specific functions. The interface typically employs certain input and output devices to input data received from a user or output data to a user. These input and output devices may include a display, mouse, keyboard, button, touchpad, touch screen, microphone, speaker, LED, light, joystick, switch, buzzer, bell, and/or other user input/output device for communicating with one or more users.

As used herein, an “engine” or “model” may refer to core elements of a computer program, or part of a computer program that serves as a foundation for a larger piece of software and drives the functionality of the software. An engine may be self-contained, but externally controllable code that encapsulates powerful logic designed to perform or execute a specific type of function. In one aspect, an engine may be underlying source code that establishes file hierarchy, input and output methods, and how a specific part of a computer program interacts or communicates with other software and/or hardware. The specific components of an engine may vary based on the needs of the specific computer program as part of the larger piece of software. In some embodiments, an engine may be configured to retrieve resources created in other computer programs, which may then be ported into the engine for use during specific operational aspects of the engine. An engine may be configurable to be implemented within any general-purpose computing system. In doing so, the engine may be configured to execute source code embedded therein to control specific features of the general-purpose computing system to execute specific computing operations, thereby transforming the general-purpose system into a specific purpose computing system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, a “large language model” may refer to advanced natural language processing models, exemplified by FLAN-T5, an evolution of Google's T5 architecture. T5, initially introduced in the paper “Exploring the Limits of Transfer Learning with a Unified Text-to-Text Transformer,” is an encoder-decoder model pre-trained on diverse tasks. FLAN-T5 stands out due to its “instruction finetuning” across over 1,800 language tasks, enhancing reasoning and adaptability. It excels in various natural language processing tasks like translation, text classification, and question answering, known for its speed and customization options.

Alternatives to FLAN-T5 include OpenAI's GPT-3, known for text generation with a unidirectional transformer. BERT is a bidirectional model ideal for context-based tasks. RoBERTa extends BERT with improved training. XLNet captures word dependencies through permutations. The upcoming GPT-4 is expected to advance natural language processing. Selection of a large language model depends on project needs, data, and resources.

Prior to the present invention, the state of technology in data record retrieval from documentation applications was marked by significant limitations. Existing search methodologies primarily relied on lexical approaches utilizing thesauri or knowledge bases, which were ill-suited for specialized corpora containing technical terms and domain-specific abbreviations. The lack of synonyms for these specialized terms hindered the effectiveness of such search queries. Moreover, common words within these data records often held distinct contextual meanings, adding complexity to the search process. While Relevance Feedback techniques showed promise in improving search precision, it demanded labor-intensive user input for document labeling, a departure from the typical user experience in search engines.

Accordingly, the technical problem at hand relates to the search and retrieval of data records originating from documentation applications, which often contain a specialized corpus with technical terms and abbreviations specific to the domain of the entity or users associated with the entity. Unlike generic document sets composed of common words and phrases, these documentation applications, analogous to CRM notes, are characterized by the usage of domain-specific terminology, where synonyms for many of these terms may not be readily available. Furthermore, the challenge is compounded by the fact that certain terms or phrases that appear in these documentation applications, while common in everyday language, hold distinct contextual meanings within specialized domains (e.g., the term “EDGE” in documentation applications within an entity may refer to a specific type of account, not the common word “edge”).

As previously mentioned, one approach to enhancing search effectiveness is the utilization of Relevance Feedback. This method initially presents users with a list of documents based on their query and prompts them to manually identify which documents are relevant and non-relevant. During this process, words and phrases that help differentiate between relevant and non-relevant documents are identified. These “expansion words” are then used to modify the original query, resulting in a refined search query. This refined query is subsequently used to retrieve a final list of search results. While the Relevance Feedback approach has proven effective in some improvement of search precision, it introduces an extra layer of effort by requiring explicit user input to label documents as relevant or non-relevant during the search process. This user-intensive interaction is not typically encountered in conventional search engine settings but becomes necessary in specialized contexts like data records with domain-specific terminology.

The present disclosure reflects the discovery of a novel solution that uses a weighting model such as a TF-IDF model to represent data records and a query statement as vectors, such as to represent the similarity between any of the data records and the query statement. The system then stochastically varies the query vector in a systematic way in order to alter the query statement itself (via the query vector parameters rather than via text query statement changes) and iteratively move the query vector towards the most pertinent results. This technology enables query statements to be formulated with linguistic terms inherent to the data records themselves, rather than by language models that may not accurately capture the lexicon of any given specialized industry or function. By then subsequently supplying the most relevant data records determined by the weighting model (and their relative rankings) to a large language model as an input, the large language model may then query a more appropriate subset of data records and supply a user with accurate data record results related to the query statement. This enables users to query large sets of data records with greater accuracy than that which would be provided by a large language model alone.

Specifically, the present disclosure introduces a system, computer program product, and method for machine learning-driven data record retrieval via stochastic expansion data querying. The process begins with retrieving data records from a repository. A query statement is received at a user interface of an endpoint device and thereby received by the system. Subsequently, the query statement and the data records are represented as vectors (query vector and data vectors) by applying a TF-IDF model, or similar weighting model. Cosine similarity scores are then calculated between each of the vectors representing the data records (i.e., data vectors) and the query vector, and the data vectors are ranked or otherwise isolated in a predetermined number based on their cosine similarity scores. At the center of the query vector, a group of stochastically generated test vectors are generated at a predetermined radius from the center of the query vector. Subsequent similarity scores (i.e. “second similarity scores”) are then calculated for each of these stochastically-generated test vectors and each data vector within the predetermined group of data vectors (those that have been selected based on their rank in cosine similarity to the query vector of the query statement). Based on the second similarity scores, a new query vector is determined. Thereafter, metrics are compared to predetermined stopping criteria. If the predetermined stopping criteria are met, the process ends by determining a final ranking of the data records and providing such ranking to a large language model. However, if the predetermined stopping criteria are not met, the system repeats the iterative process by determining based on the grouping a direction of a subsequent query vector. A predetermined quantity of subsequent test vectors is generated from the center of the subsequent query vector at a predetermined radius. The similarity score is calculated based on the similarity between each subsequent test vector and each data vector of the grouping. Based on the highest similarity score of each of the subsequent test vectors, a new subsequent query vector is determined. Thereafter, metrics are once again compared to predetermined stopping criteria. If they are not met, the previous process repeats, iteratively moving closer to a new subsequent query vector that does meet the predetermined stopping criteria. Once the predetermined stopping criteria are met, the process ends by determining a final ranking of the data records and providing such ranking to a large language model. Once the large language model has been provided this information via a “few-shot” input, the large language model may return query results and display them on an interface of the endpoint device.

What is more, the present invention provides a technical solution to a technical problem. As described herein, the root of the technical problem is the inadequacy of current search capabilities within the data records of documentation applications. They rely on basic keyword matching, requiring precise spelling and keyword order within the note's body. This limitation significantly impedes the process of extracting valuable insights, affecting the efficiency of entity teams and their ability to make informed decisions promptly. The technical solution presented herein allows the effective retrieval of data records from query statement via a large language model regardless of the query statement's linguistic complexities, alternate word definitions, unique acronyms, and so forth. In particular, the system is an improvement over existing data record query systems by providing query results (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing and manual resources.

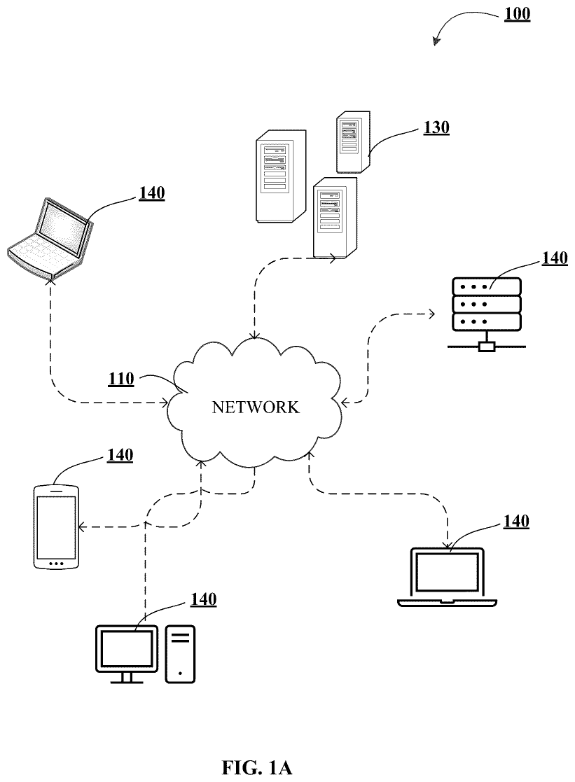

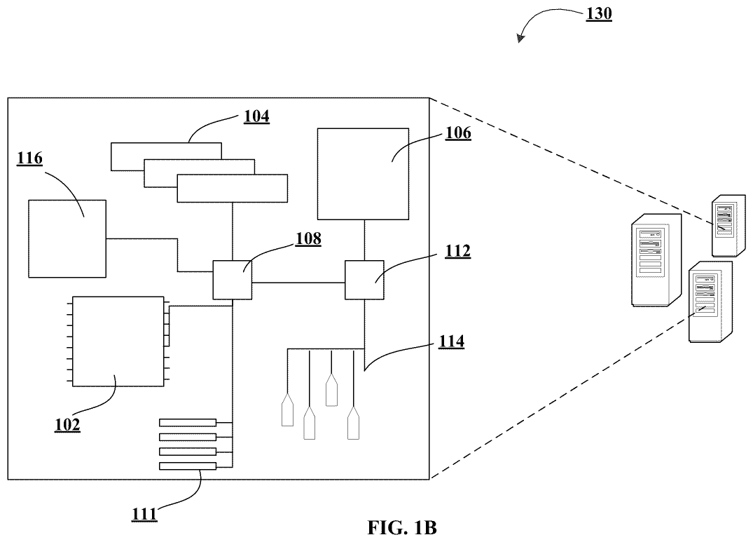

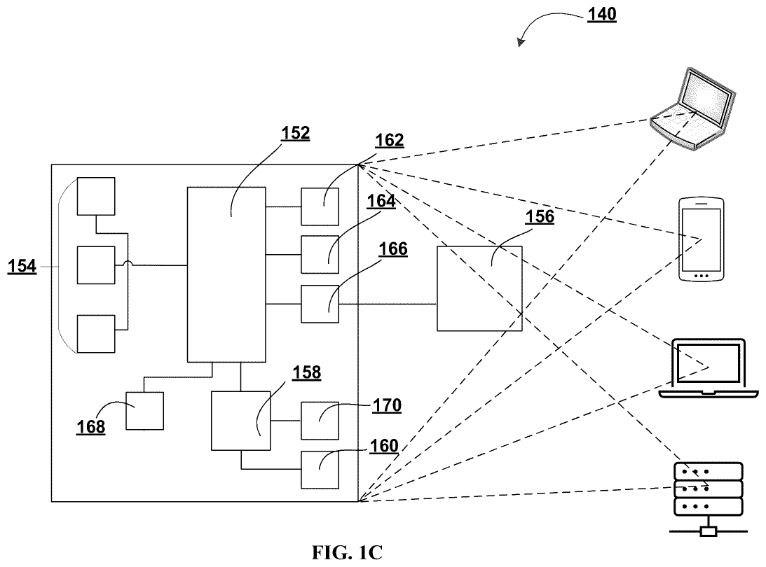

FIGS. 1A-1C illustrate technical components of an exemplary distributed computing environment 100 for machine learning-driven data record retrieval via stochastic expansion data querying, in accordance with an embodiment of the invention. As shown in FIG. 1A, the distributed computing environment 100 contemplated herein may include a system 130, an endpoint device(s) 140, and a network 110 over which the system 130 and endpoint device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the endpoint device(s) 140 may have a client-server relationship in which the endpoint device(s) 140 are remote devices that request and receive service from a centralized server, i.e., the system 130. In some other embodiments, the system 130 and the endpoint device(s) 140 may have a peer-to-peer relationship in which the system 130 and the endpoint device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The endpoint device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 connecting to low speed bus 114 and storage device 106. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 106, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

In some embodiments, system 130 may include one of more quantum computer devices. A quantum computer similarly comprises a quantum processor 102, quantum memory 104, quantum input/output (QI/O) device 116, and a quantum storage device 106. The system 130 also incorporates a high-speed quantum interface 108 to facilitating connections to the quantum memory 104, and a low-speed quantum interface 112 connecting to a low-speed quantum bus 114 and the quantum storage device 106.

Notably, the quantum components 102, 104, 108, 110, and 112 are interconnected through quantum buses that harness quantum entanglement and superposition effects. These quantum interconnections use the properties of quantum states to enable advanced computation and communication through the manipulation of qubits. In this quantum context, the quantum processor 102 encompasses distinct subsystems for executing specific quantum processes and algorithms as described herein. Each quantum computer operates as an autonomous quantum unit within the broader system 130, capable of specialized quantum computations as integral constituents of the overarching quantum architecture.

FIG. 1C illustrates an exemplary component-level structure of the endpoint device(s) 140, in accordance with an embodiment of the invention. As shown in FIG. 1C, the endpoint device(s) 140 includes a processor 152, memory 154, an input/output device such as a display 156, a communication interface 158, and a transceiver 160, among other components. The endpoint device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the endpoint device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the endpoint device(s) 140, such as control of interfaces, applications run by endpoint device(s) 140, and wireless communication by endpoint device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of endpoint device(s) 140 with other devices. External interface 168 may provide, for example, for wired communication in some implementations, or for wireless communication in other implementations, and multiple interfaces may also be used.

The memory 154 stores information within the endpoint device(s) 140. The memory 154 can be implemented as one or more of a computer-readable medium or media, a volatile memory unit or units, or a non-volatile memory unit or units. Expansion memory may also be provided and connected to endpoint device(s) 140 through an expansion interface (not shown), which may include, for example, a SIMM (Single In Line Memory engine) card interface. Such expansion memory may provide extra storage space for endpoint device(s) 140 or may also store applications or other information therein. In some embodiments, expansion memory may include instructions to carry out or supplement the processes described above and may include secure information also. For example, expansion memory may be provided as a security module for endpoint device(s) 140 and may be programmed with instructions that permit secure use of endpoint device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the endpoint device(s) 140 to transmit and/or receive information or commands to and from the system 130 via the network 110. Any communication between the system 130 and the endpoint device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the endpoint device(s) 140 may provide the system 130 (or other client devices) permissioned access to the protected resources of the endpoint device(s) 140, which may include a GPS device, an image capturing component (e.g., camera), a microphone, and/or a speaker.

The endpoint device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to endpoint device(s) 140, which may be used as appropriate by applications running thereon, and in some embodiments, one or more applications operating on the system 130.

The endpoint device(s) 140 may also communicate audibly using audio codec 162, which may receive spoken information from a user and convert it to usable digital information. Audio codec 162 may likewise generate audible sound for a user, such as through a speaker, e.g., in a handset of endpoint device(s) 140. Such sound may include sound from voice telephone calls, may include recorded sound (e.g., voice messages, music files, etc.) and may also include sound generated by one or more applications operating on the endpoint device(s) 140, and in some embodiments, one or more applications operating on the system 130.

Various implementations of the distributed computing environment 100, including the system 130 and endpoint device(s) 140, and techniques described here can be realized in digital electronic circuitry, integrated circuitry, specially designed ASICs (application specific integrated circuits), computer hardware, firmware, software, and/or combinations thereof.

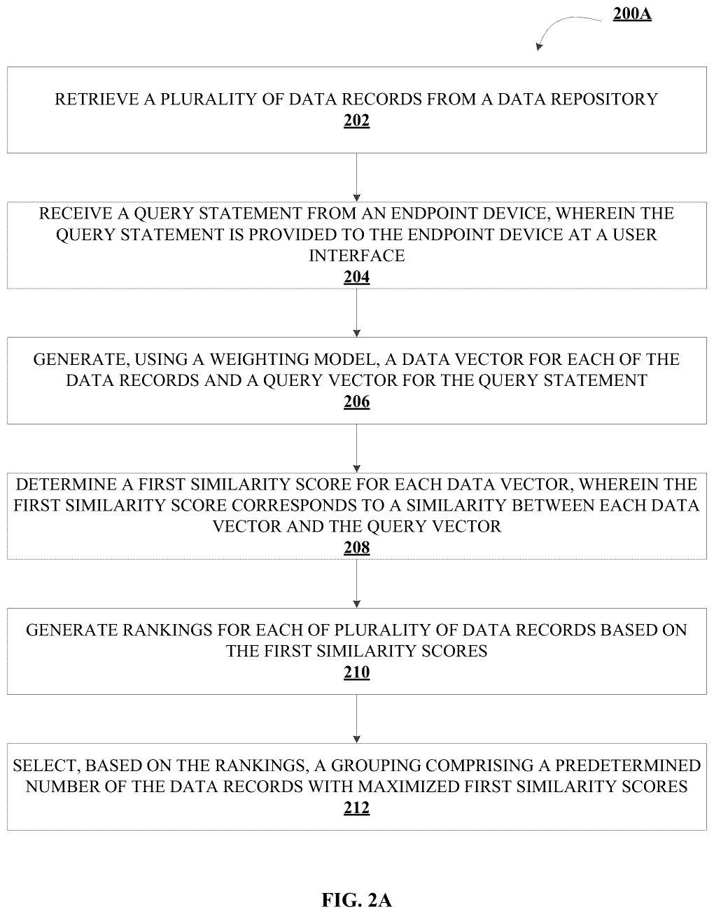

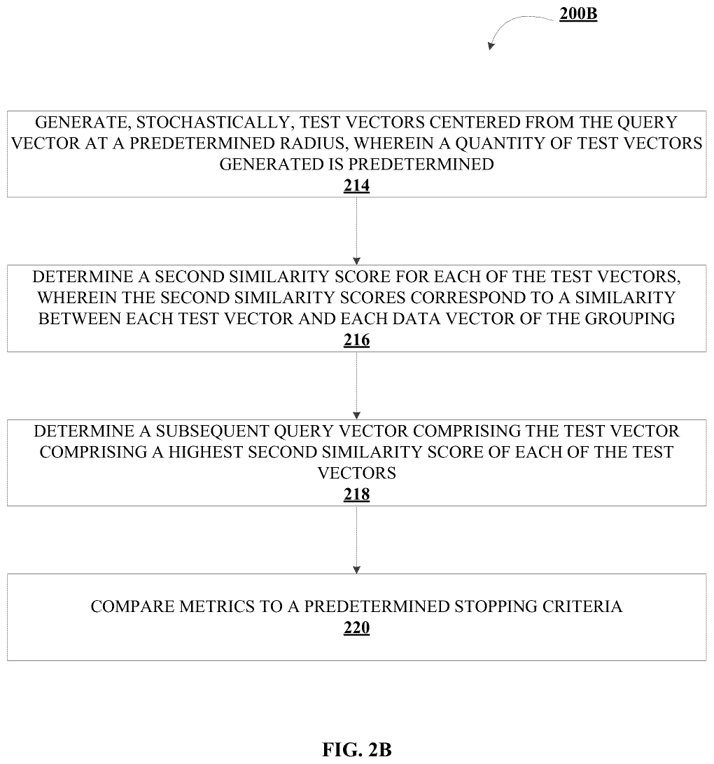

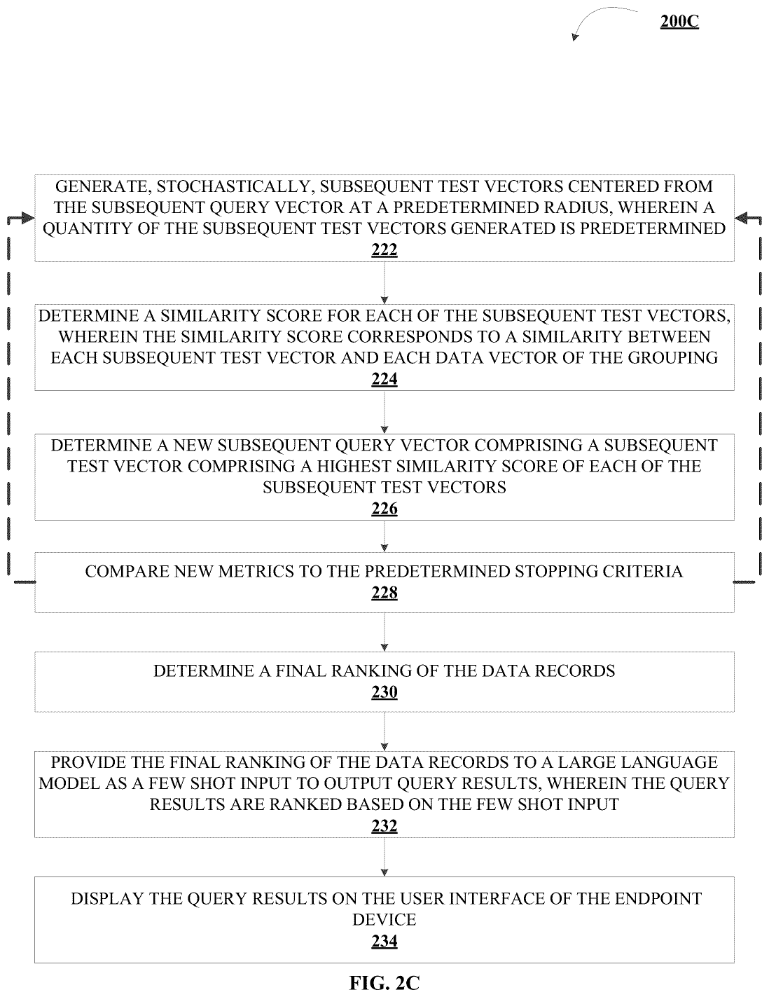

FIGS. 2A-2C illustrate a process flow for machine learning-driven data record retrieval via stochastic expansion data querying, in accordance with an embodiment of the invention. The process may begin at block 202, where the system 130 retrieves a plurality of data records from a data repository.

As used herein “data records” may refer to any text data stored that originates from a computer application on the network. As one non-limiting example, several well-known customer relationship management (CRM) software applications are used throughout an entity, where various users associated with the entity routinely document or note particularly unique descriptive narratives regarding interactions with customers, stakeholders, or the like. Another such non-limiting example may include the electronic noting or charting that occurs within electronic software records throughout an entity. Yet another non-limiting example of such computer applications may be project management software that receives text notes from managers of projects to record any status updates to a project schedule. Indeed, there are numerous contemplated computer applications that may be used in conjunction with the invention described herein. Importantly, such computer applications receive text from users, and entity systems store the text as data records within a repository or storage device of the entity.

This text data, or “data records” are often stored in a data lake or other data repositories to create backup images of the data records and allow for retrieval of such data records. Accordingly, at the initiation of the process described herein by the system 130, the system 130 may retrieve, from a data lake, some or all of the data records for a given computer application. In some embodiments, the data records to be retrieved are predetermined by a user. For example, in some embodiments, a user may indicate a date range or a time range of the data records to be retrieved. Additionally, or alternatively, a user may indicate data records associated with a specified user or account, or group within an entity.

Nonetheless, at block 204 the system 130 receives a query statement from an endpoint device 140, wherein the query statement is provided to the endpoint device 140 at a user interface. A user may be interested in querying the data records for one or more words, phrases, or the like. As such, the user generally supplies this query as a query statement into an endpoint device 140. In some embodiments, the query statement may be received from a user device programmed to provide the query statement at predetermined intervals after the system 130 is programmed to retrieve data records at a predetermined interval, such that no user interaction is required. In this way, a recurring query may provide query results based on a constant influx of new data records, allowing for the identification of relevant data records (e.g., data records that are related to the query statement) that may have not been present for the prior interaction.

Next, at block 206, the system 130 generates a data vector for each of the data records and a query vector for the query statement. The data vector(s) and the query vector are generated by a weighting model. As used herein, a “weighting model” may refer to a computational model for information retrieval for quantifying the importance of terms within a document or a corpus. One prominent example of a weighting model is TF-IDF, which stands for Term Frequency-Inverse Document Frequency. TF-IDF assigns a weight to each term based on its frequency within a specific document (Term Frequency) and its rarity across the entire corpus (Inverse Document Frequency).

In some embodiments, the weighting model may first tokenize the text associated with the data record to reduce the text into individual terms, words, and otherwise remove common words. In some embodiments, the weighting model may further reduce words to their base or root form. For example, the term “driving” may be reduced to “driv” or “drive” in order to analogize the word “driving” to “driver”, “drives”, and so forth.

For each data record, the text in the data record is used to determine “term frequency” of terms within the text, such that the number of times a term or its root are found in a data record is then divided by the total number of terms within the data record. Then, the “inverse document frequency” is determined, which indicates the importance of a term in the entire data record corpus. To do so, a logarithm is determined of the total number of data records in the corpus divided by the number of data records containing the term. A lower “inverse document frequency” score generally correlates to words of less significance.

To calculate the finale TF-IDF score, the “term frequency” is divided by the “inverse document frequency”. This weighting model highlights terms that are both frequent in a document and rare across the corpus, thus emphasizing their significance in representing the content of the document.

While TF-IDF is one example of a weighting model, there are alternative approaches, such as BM25 (Best Matching 25), which introduces parameters to control term saturation and dampening, making it more adaptable to different retrieval tasks. Other alternatives include Word Embedding-based methods, such as Word2Vec and GloVe, which represent terms as dense vectors in a continuous vector space and capture semantic relationships between words.

For a given data record, a data vector may be generated based on the weighting model. The TDF-IF scores for each term in the data record are organized into a vector such that each element of the vector represents the TDF-IF score for a specific term in the data record. In some embodiments, the length of the data vector is equal to the number of unique terms in the corpus. Put differently, the generation process assigning weights to each word within every data record. As a result, a data vector is created representing word in the data record, with a weight assigned to each word indicating its significance, which forms of a lengthy vector. Words that appear in the data record receive positive weights, while those absent from the data record are assigned a weight of zero, thus capturing the semantic context and relevance of each term within the vector representation.

For embodiments with multiple data records, each data record within the corpus is represented by a data vector. The length of the data vector corresponds to, or is equal to, the number of unique terms in the data record. Each data vector may include elements of the data record, where each element corresponds to the weighting model score (for example, the TF-IDF score) of a term within the corresponding data record.

In some embodiments, further transformation of the data vector(s) may occur. In such embodiments, the data vectors may be normalized to ensure that each vector has the same scale, for example by divide the data vector elements by a Euclidean norm of the vector.

The system 130 also generates a vector for the query statement, referred to herein as the “query vector”. Such a query vector may be generated in a similar manner as the generation of the data vector, however, the query vector will be generated for the terms within the query statement itself. The generation process assigning weights to each word within the query statement, and a query vector is created representing word in the query statement, with a weight assigned to each word indicating its significance, which forms of a lengthy vector.

Next, at block 208, the system 130 determines a first similarity score for each data vector, wherein the first similarity score corresponds to a similarity between each data vector and the query vector.

As used herein, a “similarity score” may refer to a calculated metric that determines, numerically, the similarity between two vectors in a multi-dimensional space. As will be appreciated in view of the present disclosure, although reference may be made herein to data vectors and the similarity score between the data vectors and the query vector, such similarity score determination may be made for any two vectors in a multi-dimensional space.

One such similarity score, as will be used in one particular embodiment, is the cosine similarity score, which measures the cosine of the angle between two vectors, and interprets the cosine as a score between −1 and 1, where a score of 1 indicates perfect similarity, a score of 0 indicates unrelated vectors, and a score of −1 indicates perfect dissimilarity. Notably, scores between 0 and 1 and between −1 and 0 indicate degrees of similarity and dissimilarity, respectively. In some embodiments, the data vectors may first be normalized. In other embodiments, the data vectors and the query vector will be normalized. Such normalization may occur by dividing each of the components of each vector by the Euclidean norm (the square root of the sum of the squares of the components). Next, the cosine similarity between vectors is determined using the formula (A·B)/(∥A∥*∥B∥), where A represents a data vector, and B represents the query vector (or any two vectors, as is discussed herein). A·B represents the dot product of the two vectors, and ∥A∥ and ∥B∥ represent their respective Euclidean norms.

In some embodiments, rather than a cosine similarity score, the system 130 may implement Euclidean distance, Manhattan distance, or any other metric to evaluate the data vector against the query vector.

Nonetheless, similarity scores may be determined for each data vector while using the same query vector. For example, the system 130 may first calculate a similarity score between Vector A (the query vector) to Vector B (a first data vector). Then, the system 130 may calculate a similarity score between Vector A to Vector C (a second data vector). Thereafter, upon the existence of a Vector D (a third data vector), the system 130 may calculate a similarity score between Vector A and Vector D, and so forth, for any number of data vectors.

Next, at block 212, the system 130 may select, based on rankings, a grouping comprising a predetermined number of the data records with maximized first similarity scores. This selection process can be accomplished using one of two methods. The first method involves threshold-based selection, where the system 130 sets a similarity score threshold, predetermined by domain-specific considerations or user preferences, and selects data records whose first similarity scores surpass this threshold, allowing control over the level of similarity required for inclusion. Alternatively, the system 130 may employ a greedy selection strategy, iteratively identifying and selecting data records with the highest first similarity scores until the predetermined grouping size is reached, ensuring that the most similar records are included first.

In some embodiments, the system 130 may store the grouping in a repository (i.e., a storage device). Some embodiments may use a relational database management system 130 where the grouping is represented as a database table. Alternatively, some embodiments may implement a file-based storage method or temporary storage in caches or key-value stores. In some embodiments, the selected data records of the grouping may be tagged in a tagging scheme or otherwise indicated through metadata as being within the grouping.

Next, at block 214, the system 130 may generate, stochastically, test vectors centered from the query vector at a predetermined radius. To achieve this, the system 130 starts by defining a predetermined radius, or receiving a predetermined radius from a user, based on the use case or system 130 requirements. This radius determines the maximum allowable distance from the query vector that a test vector can be located. The predetermined radius is a radius value that is established and set in advance. The determination of this radius may involve various considerations, such as maintaining a certain proximity to an initial vector or adhering to specific user-defined criteria. While the radius may vary in different situations or for different circles, it is typically chosen based on empirical testing and practical experimentation to optimize its value for the specific application or task at hand.

The generation of these test vectors typically involves randomization. The system 130 initiates a stochastic algorithm, which could be based on a probabilistic distribution, to determine the direction and magnitude of the displacement from the query vector. By utilizing a probabilistic distribution, such as a Gaussian distribution or a uniform distribution, the test vectors are generated with a degree of randomness.

For each test vector, the system 130 samples random values from the chosen distribution, adjusting the direction of the query vector accordingly. These sampled values are then used to compute the coordinates of the test vector relative to the query vector. By repeating this process multiple times, the system 130 creates a set of test vectors, each positioned stochastically around the query vector at the predetermined radius.

The quantity of test vectors (i.e., the number of test vectors) to be generated is predetermined. In some embodiments, 10 test vectors are generated. In other embodiments, 50 test vectors are generated. In yet additional embodiments, 100 test vectors are generated. Any number of test vectors to be generated may be predetermined. It shall be appreciated that the number of test vectors to be generated will be predetermined as a decision based on factors such as computing power available, time requirements, and/or network speed.

Next, at block 216, the system 130 determines a second similarity score for each of the test vectors. The second similarity scores correspond to a similarity between each test vector and each data vector of the grouping. For example, after Test Vector A, Test Vector B, and Test Vector C have been generated, similarity scores are sought against the data vectors of the grouping Data Vector X, Data Vector Y, and Data Vector Z. As such, similarities scores between Test Vector A and Data Vector X, Test Vector A and Data Vector Y, and Test Vector A and Data Vector Z will each be determined.

Continuing now at block 218, the system 130 may determine a subsequent query vector based on the second similarity scores from block 216. In some embodiments, the system 130 may first rank the second similarity scores from highest to lowest (i.e., from 1 being the most similar, to −1 being the least similar), then select the second similarity score closest to 1 (i.e., the highest second similarity score). In other embodiments, highest second similarity score may be determined from various functions within tools such as Python, SQL, R, and so forth. Nonetheless, once the highest second similarity score has been determined, the associated parameters set forth in the test vector corresponding to the highest second similarity score will be maintained and used to generate a subsequent query vector.

Next, at block 220, the system 130 may compare metrics to a predetermined stopping criteria. Predetermined stopping criteria govern when the iterative process described herein should conclude its execution. These predetermined stopping criteria are established beforehand such as to only operate within specified limits.

In some embodiments, a fixed number of iterations may be the predetermined stopping criteria. This involves setting a predetermined count of iterations as the termination condition. For example, the system 130 may be required to only run for a fixed number of times, such as 10 or 20 iterations, after which it stops operation.

Additionally, or alternatively, a distance threshold criterion may be selected as a predetermined stopping criteria. The relationship, and specifically the distance between a new query vector and the original query vector (i.e., the vector generated by directly from the query statement) during each iteration is monitored. The system 130 the distance between these vectors and defines a predetermined threshold value. If, at any point during the iterative process, the calculated distance exceeds this predefined threshold, the system 130 stops its execution. Accordingly, the system 130 prevents the new query vector from deviating too far from the original query vector, which is particularly important in applications like data record retrieval to avoid missing relevant information.

Additionally, or alternatively, metrics may be selected such as a target similarity score. For example, it may be predetermined that a similarity score between the subsequent query vector and the query vector of greater that 0.9 is acceptable for purposes of returning adequate query results. Accordingly, if the subsequent query vector has a similarity score of 0.95, the predetermined stopping criteria has been met. Similarly, in some embodiments this predetermined stopping criteria may be evaluated based on the each of the second similarity scores, such that if all of the second similarity scores are above a predetermined threshold, the predetermined stopping criteria has been met. In other embodiments, if a predetermined number of second similarity scores are above a predetermined threshold, the predetermined stopping criteria has been met.

Referring now to FIG. 2C, if the predetermined stopping criteria has not been met, the process may continue at block 222. Blocks 222 through 230 illustrate the steps of an iterative loop of the system 130, which demonstrates the refinement of the query vector (which is referred to as a subsequent query vector each time the iterative loop is executed). Through each execution of the iterative loop, the query vector is ascertained through the generation of test vectors and comparison of similarity scores to the data vectors of the grouping.

At block 222, the system 130 generates, stochastically, subsequent test vectors centered from the subsequent query vector at a predetermined radius, wherein a quantity of the subsequent test vectors generated is predetermined. It shall be appreciated that the function of block 222 is identical to that of block 214, with the exception that the test vectors generated may now be referred to as subsequent test vectors, and the subsequent test vectors are centered around the subsequent query vector determined in block 222. As such, the system 130 generates subsequent test vectors within a predetermined radius from the subsequent query vector, using stochastic algorithms based on probabilistic distributions like Gaussian or uniform distributions. The number of test vectors generated, ranging from 10 to 100 or more, is predetermined based on factors such as computing resources and time constraints.

Next, at block 224, the system 130 determines a similarity score for each of the subsequent test vectors. In a similar manner in which a similarity score was determined with respect to block 208 and block 216 (e.g., through cosine similarity or other methodologies), the similarity score here is determined as it corresponds to a similarity between each subsequent test vector and each data vector of the grouping.

Continuing now at block 226, the system 130 determines a new subsequent query vector comprising a subsequent test vector based on the subsequent test vector that has the highest similarity score of each of the subsequent test vectors. In a similar manner that the subsequent query vector is determined in block 218 based on the highest second similarity score, the new subsequent query vector is determined based on the highest similarity score of the subsequent test vectors determined in block 224.

As previously described, the process steps illustrated by block 222 through block 226 may be repeated until the new metrics satisfy the predetermined stopping criteria. At block 228, the system 130 compares the new metrics obtained from the previous iteration of the steps from block 222 to block 226 (i.e., the “new metrics”) to the predetermined stopping criteria. The predetermined stopping criteria is identical to that which was set forth as described in block 220, however, in block 228, the predetermined stopping criteria may be compared to newly generated subsequent test vectors (i.e., new subsequent test vectors) and/or the new subsequent query vectors. If the predetermined stopping criteria is not met by the new metrics, the process repeats again starting at block 222, but using the new subsequent vector previously determined in block 226 as the center point from which the subsequent test vectors are stochastically generated in block 222.

In some embodiments, the system 130 may compare the new metrics to the predetermined stopping criteria at a different portion of the iterative loop represented graphically in FIG. 2C by blocks 222-228. For example, after block 224 instead of after block 226.

Once the predetermined stopping criteria has been met, in some embodiments the system 130 at block 230 may determine a final ranking of the data records, such as to only utilize the most relevant data records. Based on the most recent query vector (either the subsequent query vector or the new subsequent query vector), the similarity scores between the most recent query vector and the data records indicate the similarity between the data records and the most recent query vector. Thus, the data records may be ranked from most relevant to least relevant, based on their similarity scores. In some embodiments, instead of the similarity score being generated based on the most recent query vector and the data records (e.g., the entirety of the data records), the similarity score may be generated based on the most recent query vector and only the grouping identified in block 212 (e.g., a subset of the data records).

Next, at block 232, the system 130 provides the final ranking of the data records to a large language model as a few-shot input. The final ranking provided to the large language model may also be accompanied with metadata indicating the location of the data records, their relative rankings, and so forth. In some embodiments, the data records themselves may be provided to the large language model as a part of the few-shot input.

Accordingly, the large language model outputs query results, wherein the query results are ranked based on the few-shot input (i.e., the input of the most relevant data records and the query statement). Finally, at block 234, the system 130 may transmit the query results to the endpoint device 140 for display on the user interface of the endpoint device 140. Ultimately, the resulting data records most relevant to the query statement provided to the system 130 in block 204 will be presented. In some embodiments, the system 130 may highlight, using a color text or a color text highlighting feature, terms or phrases that are identical to those provided to the system 130 in the query statement. Importantly, the accuracy and the domain-agnostic characteristics of the present system 130 provide query results not otherwise determined or otherwise presented efficiently through other means of searching.

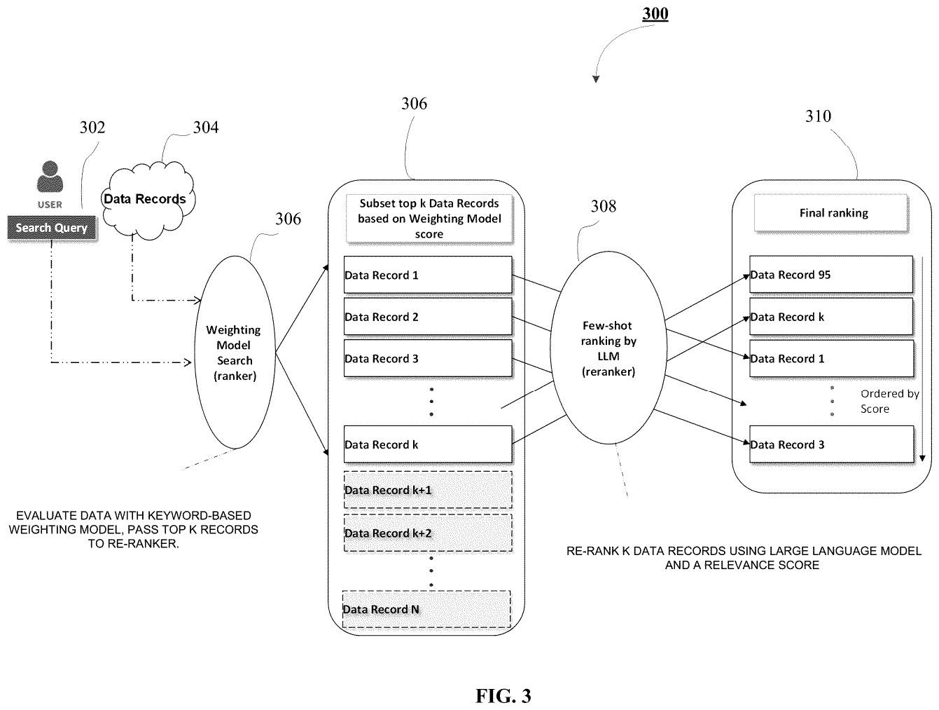

FIG. 3 illustrates a framework 300 for data record retrieval, in accordance with an embodiment of the invention. As shown in FIG. 3, a search query 302 (i.e., a query statement) is provided by a user. The weighting model 306 receives the query statement and data records 304 from a data lake or similar repository. The weighting model 306, in conjunction with the steps provided herein in FIGS. 2A-2C, provides accurately ranked data records to a large language model 308 for reranking via few-shot ranking. Thereafter, the final ranking 310 is presented to a user via a user interface, the final ranking showing those which are most relevant to the search query 302 first.

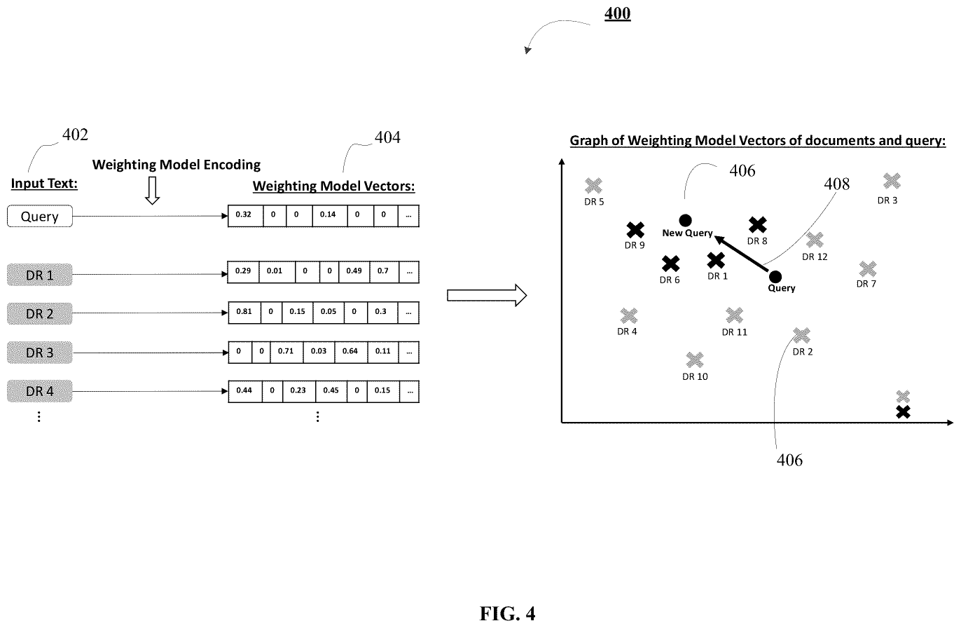

FIG. 4 illustrates an exemplary weighting model vector encoding, in accordance with an embodiment of the invention. The input text 402 is provided to the weighting model as a query statement, which is then broken down, for each word within the query statement, as weighting model vectors 404. Furthermore, the words within the data records, labeled in FIG. 4 as “DR 1”, “DR 2”, “DR 3”, “DR 4”, and so forth, are captured as a weighting model vector 404 for each data record in its entirety. The vector for the query 408 (i.e., query vector), any subsequent query vector 406, and the data vectors 406 representing each data record may be shown graphically, as illustrated in FIG. 4.

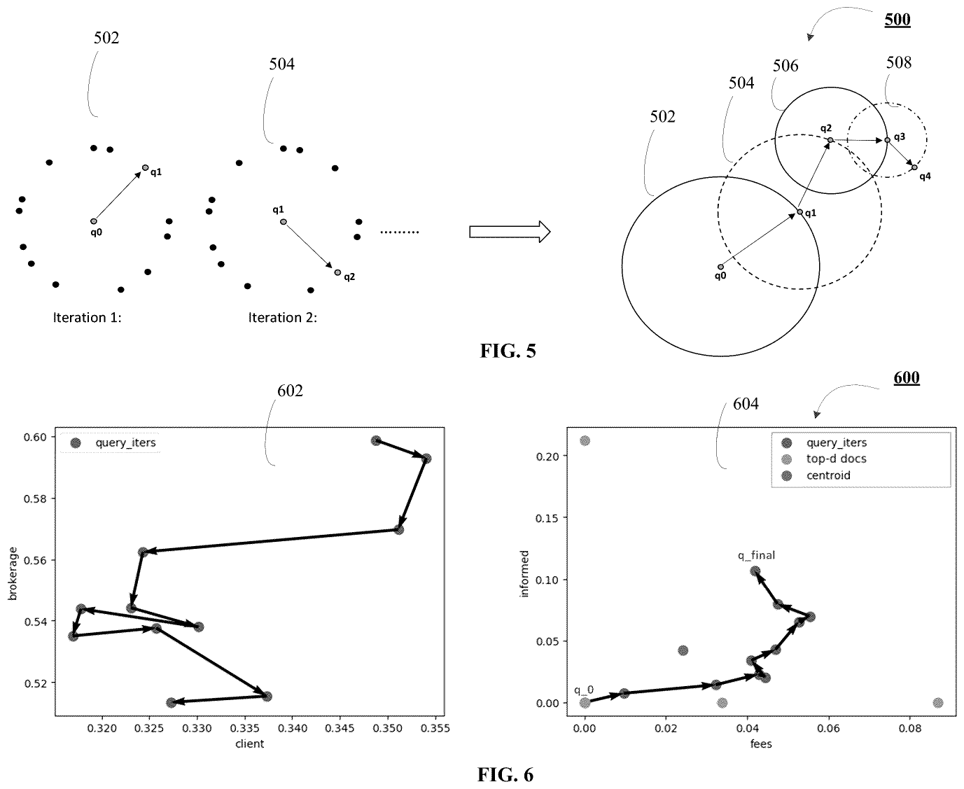

FIG. 5 illustrates an exemplary stochastic query expansion technique, in accordance with an embodiment of the invention. Test vectors 502 are generated stochastically centered around the query vector q0. Once the test vector from q0 to q1 has been determined, based on similarity scores to be the most similar to the data records in the grouping, q1 is used as a center point for new test vectors 504 to be generated for the second iteration of the process. As illustrated in FIG. 5, a series of iterations of test vectors 502, 504, 506, 508 may be generated sequentially in order to converge on a new test vector that meets predetermined criteria. FIG. 6 illustrates an exemplary graphs of stochastic query expansion technique, in accordance with an embodiment of the invention.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for machine learning-driven data record retrieval via stochastic expansion data querying, the system comprising:
a processing device; and
a non-transitory storage device comprising instructions that, when executed by the processing device, causes the processing device to perform the steps of:
retrieving a plurality of data records from a data repository;
receiving a query statement from an endpoint device, wherein the query statement is provided to the endpoint device at a user interface;
generating, using a weighting model, a data vector for each of the data records and a query vector for the query statement;
determining a first similarity score for each data vector, wherein the first similarity score corresponds to a similarity between each data vector and the query vector;
generating rankings for each of plurality of data records based on the first similarity scores;
selecting, based on the rankings, a grouping comprising a predetermined number of the data records with maximized first similarity scores; and
generating, stochastically, test vectors centered from the query vector at a predetermined radius, wherein a quantity of test vectors generated is predetermined.

2. The system of claim 1, wherein the instructions further cause the processing device to perform the steps of:
determining a second similarity score for each of the test vectors, wherein the second similarity scores correspond to a similarity between each test vector and each data vector of the grouping;
determining a subsequent query vector comprising the test vector comprising a highest second similarity score of each of the test vectors; and
comparing metrics to a predetermined stopping criteria.

3. The system of claim 2, wherein upon a condition in which the metrics do not satisfy the predetermined stopping criteria, the instructions further cause the processing device to perform the steps of:
generating, stochastically, subsequent test vectors centered from the subsequent query vector at a predetermined radius, wherein a quantity of the subsequent test vectors generated is predetermined;
determining a similarity score for each of the subsequent test vectors, wherein the similarity score corresponds to a similarity between each subsequent test vector and each data vector of the grouping; and
determining a new subsequent query vector comprising a subsequent test vector comprising a highest similarity score of each of the subsequent test vectors;
comparing new metrics to the predetermined stopping criteria.

4. The system of claim 3, wherein the instructions further cause the processing device to perform the steps of:
repeating the conditional performing until the new metrics satisfy the predetermined stopping criteria.

5. The system of claim 2, wherein the instructions further cause the processing device to perform the steps of:
determining a final ranking of the data records;
providing the final ranking of the data records to a large language model as a few-shot input to output as query results, wherein the query results are ranked based on the few-shot input; and
transmitting the query results to the endpoint device for display on the user interface of the endpoint device.

6. The system of claim 2, wherein the first similarity score and the second similarity score are cosine similarity scores.

7. The system of claim 2, wherein the metrics comprise at least one of the second similarity score, and a third similarity score corresponding to a similarity between each of the test vectors and the new query vector.

8. A computer program product for machine learning-driven data record retrieval via stochastic expansion data querying, the computer program product comprising a non-transitory computer-readable medium comprising code causing an apparatus to:
retrieve a plurality of data records from a data repository;
receive a query statement from an endpoint device, wherein the query statement is provided to the endpoint device at a user interface;
generate, using a weighting model, a data vector for each of the data records and a query vector for the query statement;
determine a first similarity score for each data vector, wherein the first similarity score corresponds to a similarity between each data vector and the query vector;
generate rankings for each of plurality of data records based on the first similarity scores;
select, based on the rankings, a grouping comprising a predetermined number of the data records with maximized first similarity scores; and
generate, stochastically, test vectors centered from the query vector at a predetermined radius, wherein a quantity of test vectors generated is predetermined.

9. The computer program product of claim 8, wherein the code further causes the apparatus to:
determine a second similarity score for each of the test vectors, wherein the second similarity scores correspond to a similarity between each test vector and each data vector of the grouping;
determine a subsequent query vector comprising the test vector comprising a highest second similarity score of each of the test vectors; and
compare metrics to a predetermined stopping criteria.

10. The computer program product of claim 9, wherein upon a condition in which the metrics do not satisfy the predetermined stopping criteria, the code further causes the apparatus to:
generate, stochastically, subsequent test vectors centered from the subsequent query vector at a predetermined radius, wherein a quantity of the subsequent test vectors generated is predetermined;
determine a similarity score for each of the subsequent test vectors, wherein the similarity score corresponds to a similarity between each subsequent test vector and each data vector of the grouping; and
determine a new subsequent query vector comprising a subsequent test vector comprising a highest similarity score of each of the subsequent test vectors.

11. The computer program product of claim 10, wherein the code further causes the apparatus to:
repeat the conditional performing until the new metrics satisfy the predetermined stopping criteria.

12. The computer program product of claim 9, wherein the code further causes the apparatus to:
determine a final ranking of the data records;
provide the final ranking of the data records to a large language model as a few-shot input to output query results, wherein the query results are ranked based on the few-shot input; and
transmit the query results to the endpoint device for display on the user interface of the endpoint device.

13. The computer program product of claim 9, wherein the first similarity score and the second similarity score are cosine similarity scores.

14. The computer program product of claim 9, wherein the metrics comprise at least one of the second similarity score, and a third similarity score corresponding to a similarity between each of the test vectors and the new query vector.

15. A method for machine learning-driven data record retrieval via stochastic expansion data querying, the method comprising:
retrieving a plurality of data records from a data repository;
receiving a query statement from an endpoint device, wherein the query statement is provided to the endpoint device at a user interface;
generating, using a weighting model, a data vector for each of the data records and a query vector for the query statement;
determining a first similarity score for each data vector, wherein the first similarity score corresponds to a similarity between each data vector and the query vector;
generating rankings for each of plurality of data records based on the first similarity scores;
selecting, based on the rankings, a grouping comprising a predetermined number of the data records with maximized first similarity scores; and
generating, stochastically, test vectors centered from the query vector at a predetermined radius, wherein a quantity of test vectors generated is predetermined.

16. The method of claim 15, wherein the method further comprises:
determining a second similarity score for each of the test vectors, wherein the second similarity scores correspond to a similarity between each test vector and each data vector of the grouping;
determining a subsequent query vector comprising the test vector comprising a highest second similarity score of each of the test vectors; and
comparing metrics to a predetermined stopping criteria.

17. The method of claim 16, wherein upon a condition in which the metrics do not satisfy the predetermined stopping criteria, the method further comprises:
generating, stochastically, subsequent test vectors centered from the subsequent query vector at a predetermined radius, wherein a quantity of the subsequent test vectors generated is predetermined;
determining a similarity score for each of the subsequent test vectors, wherein the similarity score corresponds to a similarity between each subsequent test vector and each data vector of the grouping; and
determining a new subsequent query vector comprising a subsequent test vector comprising a highest similarity score of each of the subsequent test vectors.

18. The method of claim 17, wherein the method further comprises:
repeating the conditional performing until the new metrics satisfy the predetermined stopping criteria.

19. The method of claim 16, wherein
determining a final ranking of the data records;
providing the final ranking of the data records to a large language model as a few-shot input to output query results, wherein the query results are ranked based on the few-shot input; and
transmitting the query results to the endpoint device for display on the user interface of the endpoint device.

20. The method of claim 16, wherein the first similarity score and the second similarity score are cosine similarity scores.
